(19) United States
(12) Patent Application Publication
(10) Pub. No.: US 2025/0345975 A1
(43) Pub. Date: Nov. 13, 2025

(54) PARTING LOCKING DEVICE

(71) Applicant: AIYUKI GIKEN CO., LTD., Osaka (JP)

(72) Inventor: Masatoshi NISHIMURA, Osaka (JP)

(21) Appl. No.: 18/866,807

(22) PCT Filed: Oct. 21, 2022
(86) PCT No.: PCT/JP2022/039277

§ 371 Date: Nov. 18, 2024

(51) Int. Cl. B29C 45/26

(52) U.S. Cl. CPC B29C 45/2602; B29C 2045/2604

(57) ABSTRACT

A parting locking device enables molds to be clamped together stably with a simple structure. By inserting a locking bar into a locking bar insertion hole of a base holder such that an engagement element disposed in the base holder moves to a locked position, a releasing bar is insertable into a releasing bar insertion hole of the base holder. Thereafter, by inserting the releasing bar into the releasing bar insertion hole, the movement of the engagement element to an unlocked position is restricted, so that the locking bar is prevented from moving out of the locking bar insertion hole.

### TECHNICAL FIELD

The present invention relates to a parting locking device used in a three-plate type of injection molding machine.

### BACKGROUND ART

As injection molding machines for molding a resin or a metal, three-plate type of injection molding machines are known which include, in addition to a fixed mold and a movable mold (hereinafter sometimes referred collectively to as the “both molds”) that define a cavity for molding, a stripper plate which is brought into contact with and separated from the movable mold.

In such a three-plate type of injection molding machine, a parting locking device is used so that as described below, after a product is formed, the stripper plate and the fixed mold are opened/separated, and then both molds are opened/separated.

That is, the normal molding steps in a three-plate type of injection molding machine are as follows: First, the distal end of a spool bush is inserted into the stripper plate, and, in this state, molten resin or metal material is supplied to the spool bush. The molten material supplied to the spool bush is guided to a gate of the fixed mold through a space between the stripper plate and the fixed mold, and the molten material is injected into a cavity between the fixed mold and the movable mold, and solidifies in the cavity. Thereafter, the fixed mold is moved away (separated) from the stripper plate, and a runner portion which solidified between the stripper plate and the fixed mold is separated from a product which solidified in the cavity. Lastly, the movable mold is moved away (separated) from the fixed mold, and the product is taken out.

In the above molding steps, by separating the stripper plate and the fixed plate from each other before separating both molds from each other, e.g., deformation of the product is prevented. Until the stripper plate and the fixed mold are moved away from each other to some extent, and the runner portion is separated from the product, both molds need to be kept in close contact with each other (so as not to separate from each other). The parting locking device fulfills this function.

A parting locking device is known which controls the separation order of the stripper plate and both molds by a mechanical mechanism. For example, the below-identified Patent Document 1 discloses a parting locking device comprising, as illustrated in FIG. 23, a releasing bar 52 fixed to a stripper plate (first plate) 51; a base holder 54 fixed to a fixed mold (second plate) 53 and having a bar insertion hole 54a; a locking bar 56 fixed to a movable mold (third plate) 55; a roller 57 rollably supported in the bar insertion hole 54a of the base holder 54; and a spring 58 biasing the roller 57 toward an unlocked position. The releasing bar 52 and the locking bar 56 are insertable into and removable from the bar insertion hole 54a of the base holder 54. The locking bar 56 has an engagement recess 56a which the roller 57 enters. In a state in which the releasing bar 52 is not inserted in the bar insertion hole 54a of the base holder 54 (or in a state in which only the insertion distal end portion of the releasing bar 52 is inserted in the bar insertion hole 54a as illustrated in FIG. 23), the roller 57 biased by the spring 58 is at the unlocked position.

The molds are clamped together as follows: As illustrated in FIG. 24, when the releasing bar 52 is inserted into the bar insertion hole 54a in a state in which the releasing bar 56 is inserted in the bar insertion hole 54a, an inclined surface of the releasing bar 52 at its insertion distal end portion pushes the roller 57, so that the roller 57 moves to a locked position against the elastic force of the spring 58, and enters the engagement recess 56a of the locking bar 56. The roller 57 which moved to the locked position is prevented from moving to the unlocked position by the releasing bar 52 (portion of the releasing bar 52 other than its insertion distal end portion), so that the molds 53 and 55 are kept inseparable from each other.

Therefore, when opening the molds, the molds 53 and 55 are inseparable from each other until the fixed mold 53 is moved away from the stripper plate 51 to some extent and the releasing bar 52 is pulled out of the bar insertion hole 54a of the base holder 54. When the releasing bar 52 is pulled out of the bar insertion hole 54a, the roller 57 is returned to the unlocked position by the elastic force of the spring 58, so that the molds 53 and 55 are separable from each other, and the movable mold 55 is moved away from the fixed mold 53.

### PRIOR ART DOCUMENT(S)

### Patent Document(s)

Patent Document 1: Japanese Unexamined Utility Model Application Publication No. H06-7915

### SUMMARY OF THE INVENTION

### Problems to be Solved by the Invention

In the parting locking device of Patent Document 1, there is concern that when the molds are clamped together, the releasing bar 52 is inserted into the bar insertion hole 54a of the base holder 54 before the locking bar 56 is inserted, and the roller 57 to move to the locked position, so that the locking bar 56 cannot enter the bar insertion hole 54a, and the molds cannot be clamped together. Therefore, in order to prevent the releasing bar 52 from being inserted into the bar insertion hole 54a before the locking bar 56 is inserted, a recess 52b which a portion of the roller 57 enters is disposed in the distal end of the releasing bar 52.

However, when the releasing bar 52 is inserted into the bar insertion hole 54a of the base holder 54 after the locking bar 56 is inserted, the roller 57 needs to move to the locked position against the elastic force of the spring 58 without remaining in the recess 52b of the releasing bar 52 in its distal end. Therefore, it is difficult to design the shape of the recess 52b of the releasing bar 52, and adjust the elastic force of the spring 58. Therefore, it may be impossible to reliably avoid a situation where the molds cannot be clamped together due to insertion of the releasing bar 52 into the bar insertion hole 54a of the base holder 54 before insertion of the locking bar 56.

It is an object of the present invention to provide a parting locking device that enables molds to be clamped together stably with a simple structure.

### Means for Solving the Problems

In order to achieve the above object, the present invention provides a parting locking device comprising: a base holder having a releasing bar insertion hole and a locking bar insertion hole extending parallel to each other; a releasing bar insertable into and removable from the releasing bar insertion hole; a locking bar insertable into and removable from the locking bar insertion hole; and an engagement element disposed in the base holder, wherein the base holder has a guide hole for guiding movement of the engagement element in a direction orthogonal to a direction in which the releasing bar insertion hole and the locking bar insertion hole extend, wherein the guide hole includes: a communication path extending through a partition wall between the releasing bar insertion hole and the locking bar insertion hole; and a storage recess formed in an inner surface of a side wall opposed to the partition wall with the locking bar insertion hole located between the side wall and the partition wall, wherein the engagement element includes: a stopper portion configured to retractably protrude into the releasing bar insertion hole from the communication path of the guide hole; a first engagement portion configured to retractably protrude into the locking bar insertion hole from the communication path of the guide hole; and a second engagement portion configured to retractably protrude into the locking bar insertion hole from the storage recess of the guide hole, wherein the releasing bar includes an abutment portion disposed at an insertion distal end portion of the releasing bar configured to be inserted into the releasing bar insertion hole, the abutment portion being configured to abut against the stopper portion protruding into the releasing bar insertion hole, wherein the locking bar includes: a recessed first cam portion configured to selectively receive the first engagement portion of the engagement element, and push the first engagement portion into the communication path of the guide hole according to directions in which the locking bar moves when the locking bar is inserted and removed; and a second cam portion configured such that the second engagement portion of the engagement element protruding into the locking bar insertion hole is pushed into the storage recess of the guide hole by the second cam portion, wherein the parting locking device is configured such that in a state in which the locking bar is not inserted in the locking bar insertion hole, the engagement element is at an unlocked position in which the stopper portion protrudes into the releasing bar insertion hole so as to prevent insertion of the releasing bar, the first engagement portion retracts into the communication path of the guide hole, and the second engagement portion protrudes into the locking bar insertion hole, wherein the parting locking device is configured such that when the locking bar is inserted into the locking bar insertion hole, the second cam portion pushes the second engagement portion of the engagement element, so that the engagement element moves to a locked position in which the second engagement portion retracts into the storage recess of the guide hole, the first engagement portion protrudes into the locking bar insertion hole and enters the first cam portion of the locking bar, and the stopper portion retracts into the communication path of the guide hole, wherein the parting locking device is configured such that when the engagement element is at the locked position, the releasing bar inserted in the releasing bar insertion hole restricts movement of the engagement element to the unlocked position, thereby preventing the locking bar from moving out of the locking bar insertion hole, and wherein the parting locking device is configured such that when the locking bar is pulled out of the locking bar insertion hole in a state in which the engagement element is at the locked position and the releasing bar is not inserted in the releasing bar insertion hole, the first cam portion pushes the first engagement portion of the engagement element, thereby returning the engagement element to the unlocked position.

As used herein, the sentence “state in which - - - the releasing bar is not inserted in the releasing bar insertion hole” in the above arrangement includes a state in which the insertion distal end portion of the releasing bar is inserted in the releasing bar insertion hole, but the releasing bar does not restrict the movement of the engagement element to the unlocked position.

According to the above arrangement, with a simple structure requiring only the base holder, the releasing bar, the locking bar and the engagement element as essential elements, the stopper portion of the engagement element located at the unlocked position prevents the insertion of the releasing bar into the releasing bar insertion hole in a state in which the locking bar is not inserted in the locking bar insertion hole, and when the locking bar is inserted into the locking bar insertion hole, the engagement element moves to the locked position. Therefore, it is possible to avoid a situation where the releasing bar is inserted before the locking bar is inserted and molds cannot be clamped together, and it is possible to clamp the molds together stably.

If a spring biasing the engagement element toward the unlocked position is disposed in the base holder, while the locking bar is not inserted in the locking bar insertion hole, it is possible to more reliably retain the engagement element at the unlocked position, and prevent the releasing bar from being inserted accidentally.

It is desirable that the stopper portion of the engagement element has a thickness dimension smaller than a thickness dimension of the releasing bar, the releasing bar has a recess disposed in a portion of the insertion distal end portion in a thickness direction, and including the abutment portion, and the releasing bar has convex circular arc-shaped surfaces on both sides of a distal end surface of a portion of the insertion distal end portion other than the recess of the releasing bar. As used herein, the direction of “the thickness” of each member refers to the direction orthogonal to both of the direction in which the releasing bar insertion hole and the locking bar insertion hole extend and the direction in which the engagement element moves. With this arrangement, even when the releasing bar located away from the base holder and the releasing bar insertion hole are somewhat displaced from each other, it is possible to smoothly insert the insertion distal end portion of the releasing bar into the releasing bar insertion hole.

### Effects of the Invention

With respect to the parting locking device of the present invention, as described above, by inserting the locking bar into the locking bar insertion hole of the base holder such that the engagement element, which is disposed in the base holder, moves to the locked position, the releasing bar is insertable into the releasing bar insertion hole of the base holder. Thereafter, by inserting the releasing bar into the releasing bar insertion hole, the movement of the engagement element to the unlocked position is restricted. Therefore, with a simple structure, it is possible to prevent the releasing bar from being inserted accidentally before the locking bar is inserted, and to clamp the molds together stably.

### BRIEF DESCRIPTION OF THE DRAWINGS

FIG. 1 is a front view schematically illustrating a portion of an injection molding machine in which a parting locking device according to an embodiment of the present invention is used (state in which molds are clamped together).

FIG. 2 is an exploded perspective view of the parting locking device of FIG. 1 when seen from an oblique upper side.

FIG. 3 is an exploded perspective view of a portion of FIG. 2 when seen from an oblique lower side.

FIG. 4 is a front view of the parting locking device of FIG. 1 in a state in which the molds have not been clamped together yet (and a lid is removed).

FIG. 5 is a sectional view taken along line V-V of FIG. 4.

FIG. 6 is a partially cut out front view corresponding to FIG. 4, and illustrating a state in which the molds are in the process of being clamped together.

FIG. 7 is a partially cut out front view corresponding to FIG. 4, and illustrating a state subsequent to FIG. 6 in which the molds are in the process of being clamped together.

FIG. 8 is a sectional view taken along line VIII-VIII of FIG. 7.

FIG. 9 is a front view corresponding to FIG. 1, and illustrating a state in which the molds are in the process of being opened.

FIG. 10 is a front view corresponding to FIG. 1, and illustrating a state subsequent to FIG. 9 in which the molds are in the process of being opened.

FIG. 11 is a front view corresponding to FIG. 1, and illustrating a state in which the molds are open.

FIG. 12 is an exploded perspective view illustrating a variation of a releasing bar and an engagement element when seen from an oblique upper side.

FIG. 13 is an exploded perspective view of the releasing bar and the engagement element of FIG. 12 when seen from an oblique lower side.

FIG. 14 is a partially cut out front view illustrating a state in which the molds have not been clamped together yet with the releasing bar and the engagement element of FIGS. 12 and 13 used (and with the lid removed).

FIG. 15 is an exploded perspective view illustrating a variation of a locking bar and the engagement element.

FIG. 16 is a partially cut out front view illustrating a state (state corresponding to FIG. 6) in which the molds are in the process of being clamped together with the variation of FIG. 15 used.

FIG. 17 is a partially cut out front view illustrating a state subsequent to FIG. 16 (state corresponding to FIG. 7) in which the molds are in the process of being clamped together.

FIG. 18 is an exploded perspective view illustrating a different variation of the locking bar and the engagement element.

FIG. 19 is a front view illustrating a state (state corresponding to FIG. 6) in which the molds are in the process of being clamped together with the variation of FIG. 18 used.

FIG. 20 is a front view illustrating a state subsequent to FIG. 19 (state corresponding to FIG. 7) in which the molds are in the process of being clamped together.

FIG. 21 is an exploded perspective view illustrating a still different variation of the locking bar and the engagement element.

FIG. 22 is a front view illustrating a state (state corresponding to Fig, 7) in which the molds are in the process of being clamped together with the variation of FIG. 21 used.

FIG. 23 is a cross-sectional plan view illustrating a state in which molds are opened by a conventional parting locking device.

FIG. 24 is a cross-sectional plan view illustrating a state in which the molds are clamped together by the parting locking device of FIG. 23.

### BEST MODE FOR CARRYING OUT THE INVENTION

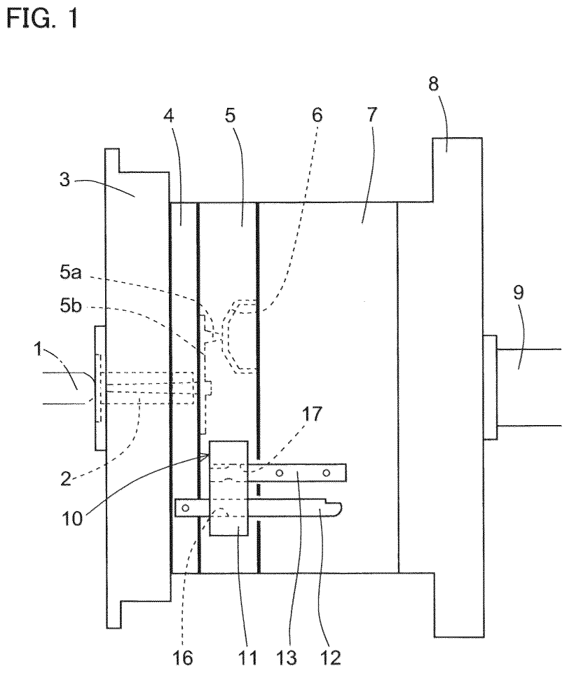

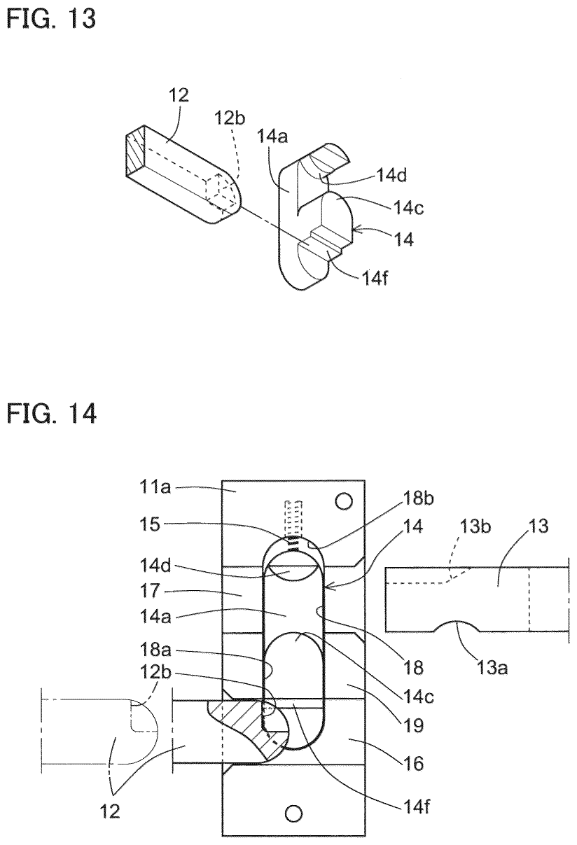

An embodiment of the present invention is described below with reference to FIGS. 1 to 22. FIG. 1 illustrates a horizontal injection molding machine in which a parting locking device 10 of the embodiment is used. This injection molding machine is a three-plate type of machine including a spool bush 2 to which molten resin is supplied from a nozzle 1 at the distal end of an injection device (not shown); a spool plate 3 to which the spool bush 2 is attached; a stripper plate 4 in which the distal end of the spool bush 2 is located; a fixed mold 5 configured to be brought into contact with, and separated from, the stripper plate 4; a movable mold 7 defining, between the fixed mold 5 and the movable mold 7, a cavity 6 for molding; a movable plate 8 supporting the movable mold 7; and a cylinder 9 configured to move the movable plate 8 horizontally forward and backward together with the movable mold 7. The fixed mold 5 is provided with a gate 5a constituting an inlet to the cavity 6; and a flow path 5b by which molten resin supplied through the spool bush 2 is guided to the gate 6a.

Parting locking devices 10 of the embodiment are mounted to both sides (the front side shown in FIG. 1 and the back side (not shown)) of this injection molding machine. Each parting locking device 10 includes a base holder 11 fixed to the fixed mold 5; a releasing bar 12 fixed to the stripper plate 4; and a locking bar 18 fixed to the movable mold 7.

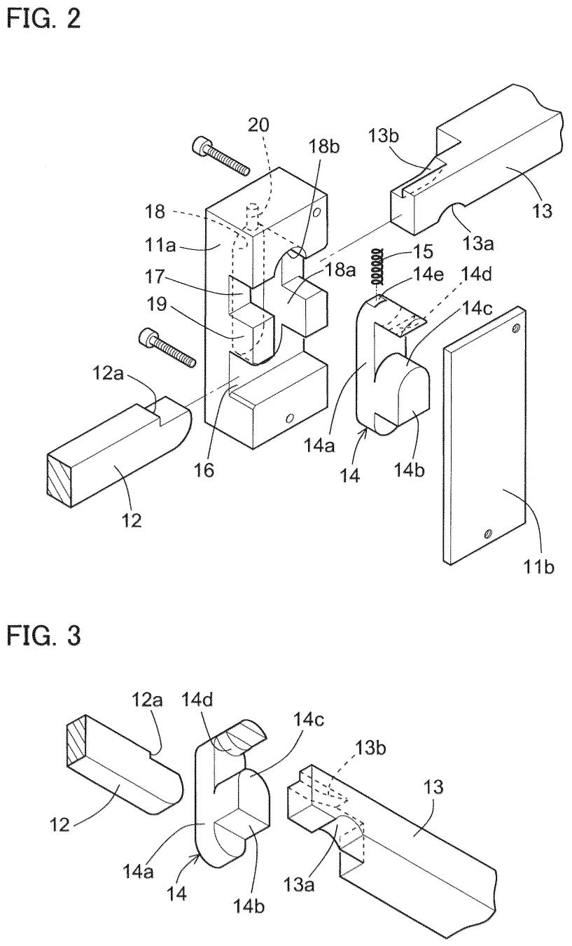

In the parting locking device 10, as illustrated in FIG. 2, the base holder 11 is divided into a holder body 11a and a lid 11b fastened to the holder body 11a by bolts, and an engagement element 14, and a spring 15 biasing the engagement element 14 toward an unlocked position (described later) are disposed in the holder body 11a.

The holder body 11a of the base holder 11 has a releasing bar insertion hole 16 and a locking bar insertion hole 17 (hereinafter sometimes referred collectively to as the “bar insertion holes 16 and 17”) extending parallel to each other in the horizontal direction with the base holder 11 fixed to the fixed mold 5. The entire releasing bar 12 can be inserted into and removed from the releasing bar insertion hole 16, and the insertion distal end portion of the locking bar 18 can be inserted into and removed from the locking bar insertion hole 17.

Also, the holder body 11a has a guide hole 18 that guides the movement of the engagement element 14 in the direction orthogonal to the direction in which the bar insertion holes 16 and 17 extend (i.e., in the vertical direction with the base holder 11 fixed to the fixed mold 5). The guide hole 18 includes a communication path 18a extending through a partition wall 19 between the releasing bar insertion hole 16 and the locking bar insertion hole 17; and a storage recess 18b formed in the inner surface of a side wall opposed to the partition wall 19 with the locking bar insertion hole 17 located therebetween. A spring storage hole 20 for storing the spring 15 communicates with the upper end of the guide hole 18.

As illustrated in FIGS. 2 to 4, the engagement element 14 includes a base portion 14a having a narrow width thick plate shape, and further includes, on one surface of the base portion 14a, a stopper portion 14b, a first engagement portion 14c and a second engagement portion 14d.

The base portion 14a of the engagement element 14 has a thickness dimension equal to the depth from the bottoms of the bar insertion holes 16 and 17 to the bottom of the guide hole 18, so that the base portion 14a does not protrude into the bar insertion holes 16 and 17. Both end surfaces of the base portion 14a are formed as convex circular are-shaped surfaces, and a flat, spring receiving surface 14e is disposed only at the portion of the upper end surface thereof opposed to one end of the spring 15.

A protrusion that fits into the communication path 18a of the guide hole 18 is disposed on the lower end portion of the one surface of the base portion 14a. The lower portion of the protrusion has a rectangular shape, and the upper portion of the protrusion has a semicircular shape in front view. The lower end portion of the protrusion constitutes the stopper portion 14b, which is configured to retractably protrude into the releasing bar insertion hole 16 from the communication path 18a, and the upper end portion of the protrusion constitutes the first engagement portion 14c, which is configured to retractably protrude into the locking bar insertion hole 17 from the communication path 18a.

A different protrusion is disposed on the upper end portion of the one surface of the base portion 14a. The lower portion of the protrusion constitutes the second engagement portion 14d, which is configured to retractably protrude into the locking bar insertion hole 17 from the storage recess 18b of the guide hole 18. The second engagement portion 14d has an arched shape in front view, and has a thickness that is about half of the thickness of the insertion distal end portion of the locking bar 13.

The releasing bar 12 has a recess formed by cutting out the entire upper surface of its insertion distal end portion in the thickness direction. The surface of the recess facing the insertion distal end portion constitutes an abutment portion 12a that abuts against the stopper portion 14b of the engagement element 14 protruding into the releasing bar insertion hole 16. In order to smoothly insert the releasing bar 12 into the releasing bar insertion hole 16, the distal end surface of the insertion distal end portion is formed as a convex circular arc-shaped surface.

With respect to the locking bar 13, only the insertion distal end portion thereof, which has a small thickness dimension, can be inserted into and removed from the locking bar insertion hole 17. The insertion distal end portion thereof has a first cam portion 13a on the lower surface, and a second cam portion 13b on the upper surface. The first cam portion 18a is formed by cutting out, into a concave circular are-shape, the entire lower surface of the insertion distal end portion in the thickness direction. As described later, the first cam portion 13a selectively receives the first engagement portion 14c of the engagement element 14, and pushes the first engagement portion 14c into the communication path 18a of the guide hole 18 according to the directions in which the locking bar 13 moves when the locking bars 13 is inserted and removed. On the other hand, the second cam portion 13b is formed by cutting out the back side of the upper surface of the insertion distal end portion from the distal end. As described later, the second cam portion 13b pushes, into the storage recess 18b of the guide hole 18, the second engagement portion 14d of the engagement element 14 protruding into the locking bar insertion hole 17.

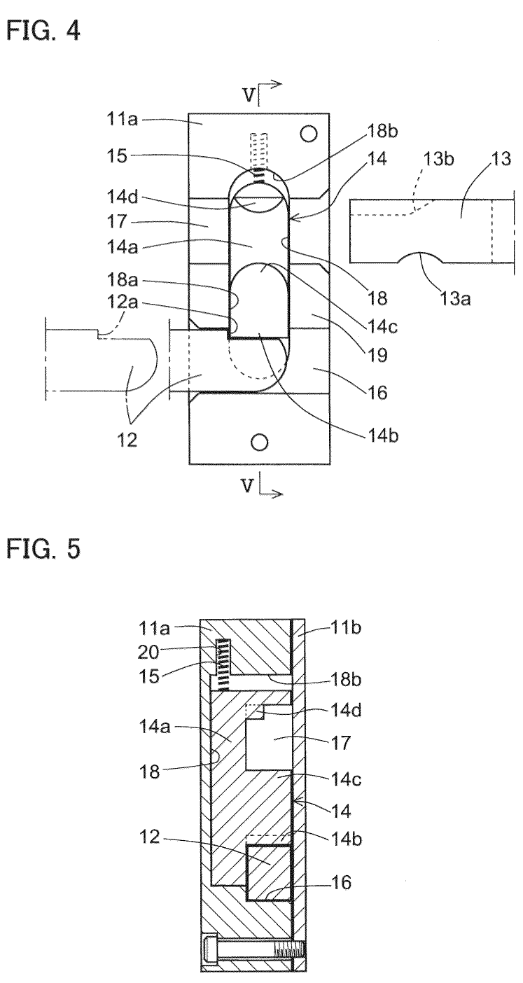

With respect to this parting locking device 10, which has the above structure, as illustrated in FIGS. 4 and 5, in a state in which the insertion distal end portion of the locking bar 18 is not inserted in the locking bar insertion hole 17, the engagement element 14 is at an unlocked position in which the stopper portion 14b protrudes into the releasing bar insertion hole 16, the first engagement portion 14c retracts into the communication path 18a of the guide hole 18, and the second engagement portion 14d protrudes into the locking bar insertion hole 17. In this state, even if the insertion distal end portion of the releasing bar 12 is inserted into the releasing bar insertion hole 16, the abutment portion 12a of the insertion distal end portion abuts against the stopper portion 14b of the engagement element 14, thereby preventing the insertion of the releasing bar 12.

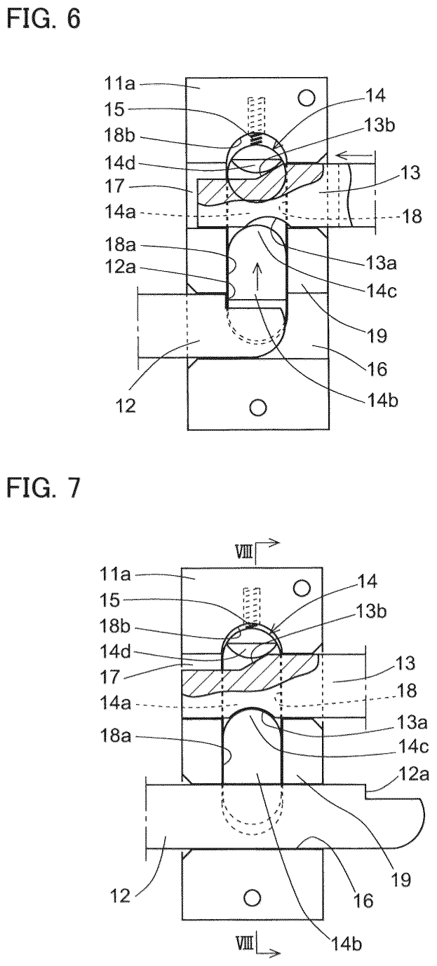

When, in the state shown in FIGS. 4 and 5, the insertion distal end portion of the locking bar 13 is inserted into the locking bar insertion hole 17, as illustrated in FIG. 6, the second cam portion 13b of the locking bar 18 pushes the second engagement portion 14d of the engagement element 14 midway, so that the engagement portion 14 moves to a locked position in which the second engagement portion 14d retracts into the storage recess 18b of the guide hole 18 against the elastic force of the spring 15, the first engagement portion 14c protrudes into the locking bar insertion hole 17 and enters the first cam portion 13a of the locking bar 13, and the stopper portion 14b retracts into the communication path 18a of the guide hole 18.

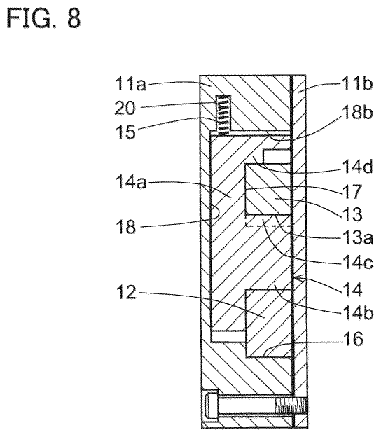

As illustrated in FIGS. 7 and 8, when the releasing bar 12 is inserted into the releasing bar insertion hole 16 with the engagement element 14 moved to the locked position by the insertion of the locking bar 18 into the locking bar insertion hole 17, the releasing bar 12 restricts the movement of the engagement element 14 to the unlocked position, thereby preventing the locking bar 13 from moving out of the locking bar insertion hole 17.

Therefore, in the injection molding machine in which this parting locking device 10 is used (on each side), after, in the state in which the molds are open/separated, the movable mold 7 is moved toward the fixed mold 6 until the movable mold 7 comes into close contact with the fixed mold 5; and the insertion distal end portion of the locking bar 13 is inserted into the locking bar insertion hole 17 of the base holder 11, by moving the molds 5 and 7 together toward the stripper plate 4; and inserting the releasing bar 12 into the releasing bar insertion hole 16 of the base holder 11, the molds 5 and 7 are kept inseparable from each other. Furthermore, by bringing the fixed mold 5 into close contact with the stripper plate 4; and bringing the stripper plate 4 into close contact with the spool plate 8, the molds are clamped together as illustrated in FIG. 1. In this state, molten resin is supplied from the nozzle 1 of the injection device to the spool bush 2, and molding is conducted.

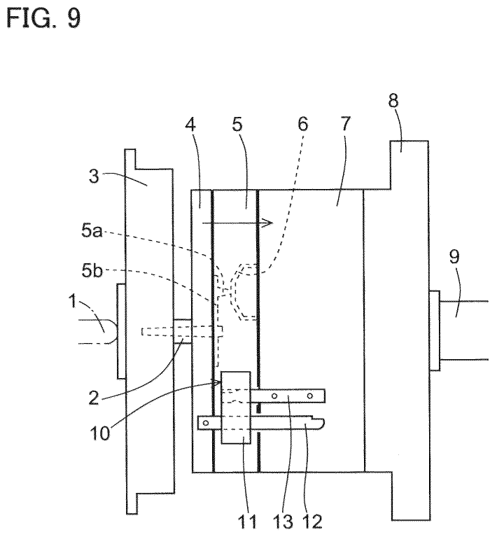

After completing the molding, the movable plate 8 and the movable mold 7 are moved together by the cylinder 9 in the direction away from the nozzle 1 of the injection device so as to open the molds. When opening the molds, first as illustrated in FIG. 9, the stripper plate 4 and the fixed mold 5 are also moved together with the movable mold 7 and the movable plate 8 by the action of a pulling pin (not shown), and the stripper plate 4 is separated from the spool plate 3.

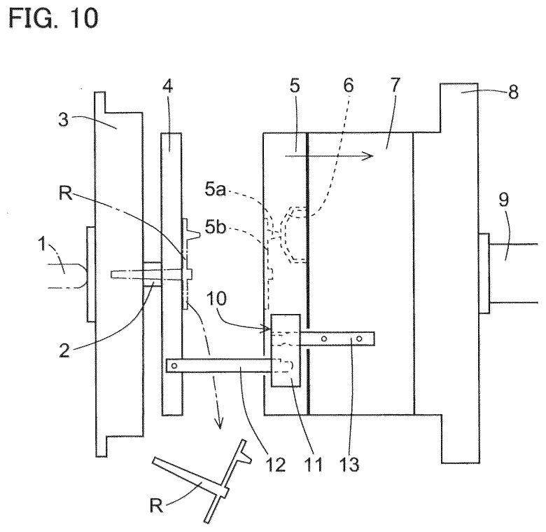

The stripper plate 4 stops due to the action of the pulling pin when moving away from the spool plate 8 to some extent. At this time, since the fixed mold 5 is inseparable from the movable mold 7 by the parting locking device 10, the fixed mold 5 continues to move together with the movable mold 7 and the movable plate 8. Due to this, as illustrated in FIG. 10, the fixed mold 5 is separated from the stripper plate 4, and a runner portion R of resin remaining in the spool bush 2 and the gate 5a and the flow path 5b of the fixed mold 5 is separated and removed.

Also, at the same time, the releasing bar 12, which is fixed to the stripper plate 4, starts to move out of the base holder 11, which is fixed to the fixed mold 5. Then, the releasing bar 12 moves out of the base holder 11 such that only the insertion distal end portion thereof remains in the base holder 11, and thus the releasing bar 12 no longer restricts the movement of the engagement element 14 to the unlocked position. As a result, the molds 5 and 7 are kept separable from each other, and the fixed mold 6 stops due to the action of the pulling pin.

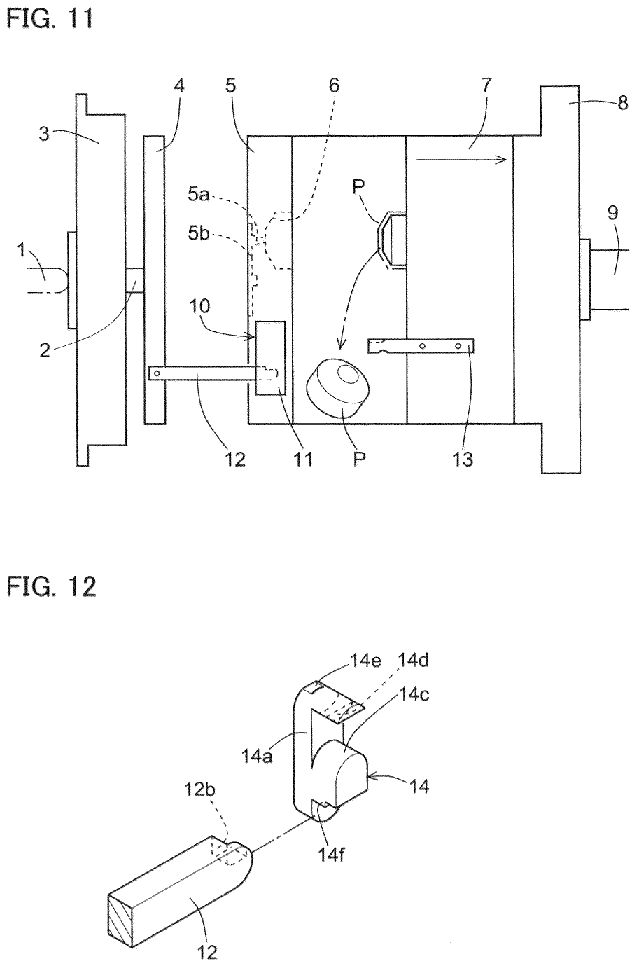

When the fixed mold 5 stops, as illustrated in FIG. 11, the movable mold 7 is separated from the fixed mold 5 such that the molds are opened, and a product P formed in the cavity 6 is taken out. Also, at the same time, the insertion distal end portion of the locking bar 13, which is fixed to the movable mold 7, starts to move out of the base holder 11, and the first cam portion 13a of the locking bar 18 pushes the first engagement portion 14c of the engagement element 14 midway, so that the engagement element 14 is returned to the unlocked position by its own weight and the elastic force of the spring 16 (the engagement element 14 is returned to the state shown in FIG. 4 by the movement in the direction opposite from the relevant arrow in FIG. 6).

As described above, this parting locking device 10 functions to prevent separation of the molds 5 and 7 until the stripper plate 4 and fixed side mold 5 are separated from each other. Also, when clamping the molds together, by inserting the locking bar 13 into the locking bar insertion hole 17 of the base holder 11 such that the engagement element 14, which is disposed in the base bolder 11, moves to the locked position, the releasing bar 12 is insertable into the releasing bar insertion hole 16 of the base holder 11. Thereafter, when inserting the releasing bar 12 into the releasing bar insertion hole 16, the movement of the engagement element 14 to the unlocked position is restricted. Therefore, with a simple structure, it is possible to prevent the releasing bar 12 from being inserted accidentally before the locking bar 18 is inserted, and to clamp the molds together stably.

FIGS. 12 to 14 illustrate a variation of the releasing bar 12 and the engagement element 14. In this variation, the stopper portion 14f of the engagement element 14 has a thickness dimension smaller than the thickness dimension of the releasing bar 12, and the releasing bar 12 has a recess disposed in a portion of its insertion distal end portion in the thickness direction, and including an abutment portion 12b that abuts against the stopper portion 14f protruding into the releasing bar insertion hole 16. Due to this, even when the releasing bar 12 located away from the base holder 11 (releasing bar 12 in the state shown by the one dot chain line in FIG. 14) and the releasing bar insertion hole 16 are somewhat displaced from each other, it is possible to insert the insertion distal end portion of the releasing bar 12 into the releasing bar insertion hole 16b more smoothly than in the example shown in FIGS. 1 to 11.

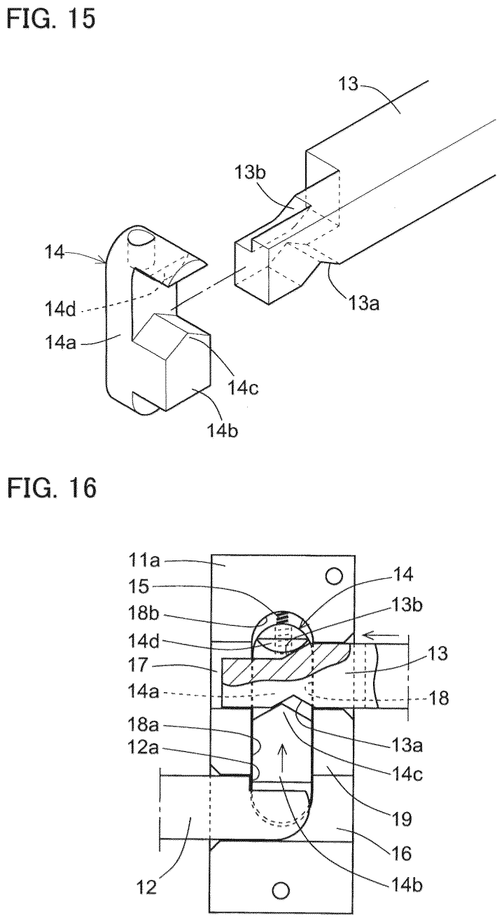

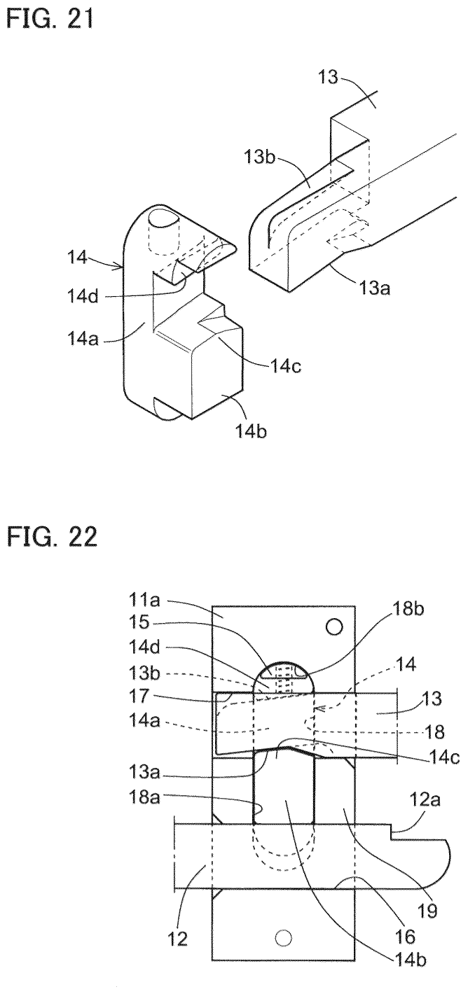

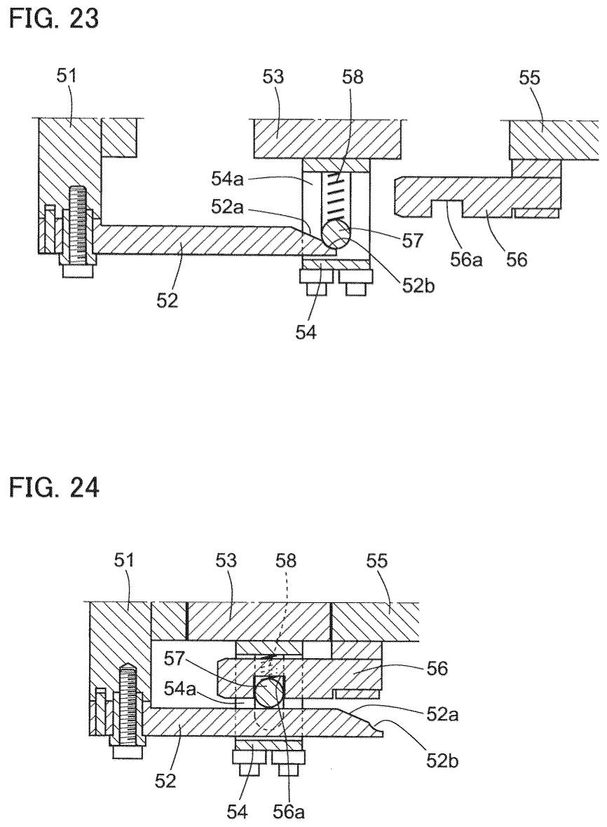

FIGS. 15 to 22 illustrate first to third variations of the locking bar 13 and the engagement element 14. In the first variation of FIGS. 15 to 17, the first cam portion 13a of the locking bar 13 and the first engaging portion 14c of the engagement element 14 are formed, respectively, as concave and convex portions having a triangular shape in front view and configured to be fitted to each other. In the second variation of FIGS. 18 to 20, each of the surfaces of the first and second engagement portions 14c and 14d of the engagement element 14 that protrude into the locking bar insertion hole 17 is formed as a single flat inclined surface, and flat inclined surfaces are formed, respectively, on the first and second cam portions 13a and 13b of the locking bar 13 so as to slide on the inclined surfaces of the first and second engagement portions 14c and 14d. In the third variation shown in FIGS. 21 and 22, which is based on the second variation, of the first cam portion 13a of the locking bar 13 and the first engagement portion 14e of the engagement element 14, the portions on the front side have a triangular shape as in the first variation.

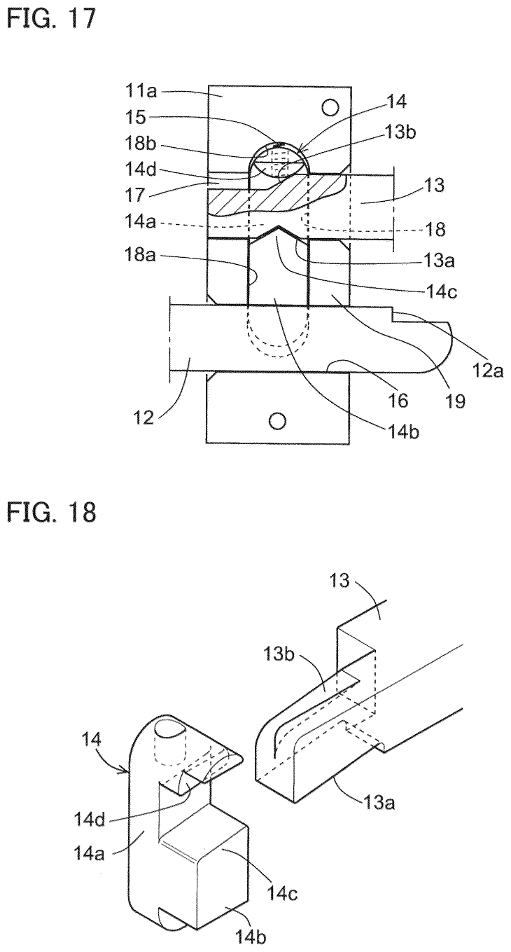

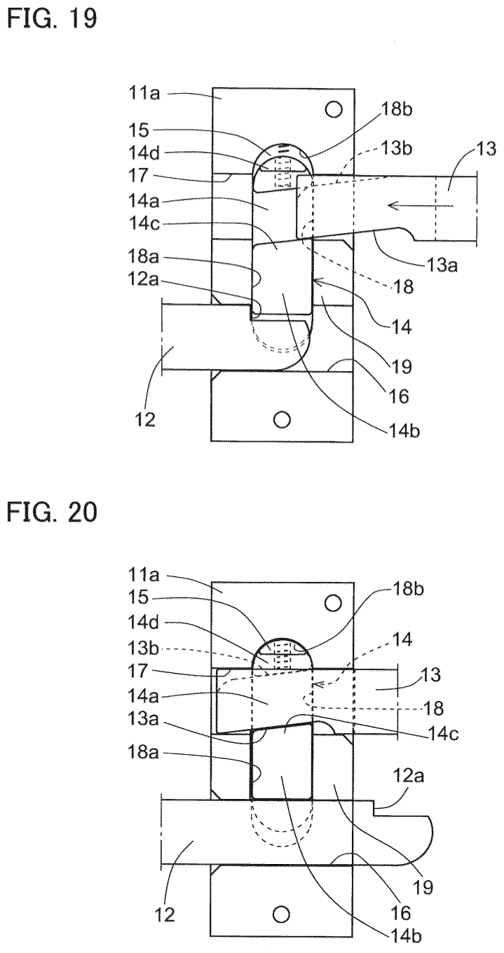

In these variations, too, as illustrated in FIGS. 16 and 19, when the insertion distal end portion of the locking bar 13 is inserted into the locking bar insertion hole 17, the engagement portion 14 moves to a locked position in which the second engagement portion 14d pushed by the second cam portion 13b of the locking bar 13 retracts into the storage recess 18b of the guide hole 18, the first engagement portion 14c protrudes into the locking bar insertion hole 17 and enters the first cam portion 18a of the locking bar 13, and the stopper portion 14b retracts into the communication path 18a of the guide hole 18 (this is not shown with respect to the third variation). Thereafter, as illustrated in FIGS. 17, 20 and 22, when the releasing bar 12 is inserted into the releasing bar insertion hole 16 with the engagement element 14 moved to the locked position, the releasing bar 12 restricts the movement of the engagement element 14 to the unlocked position, thereby preventing the locking bar 13 from moving out of the locking bar insertion hole 17.

The above-described embodiment is a mere example in every respect, and the present invention is not limited thereto. The scope of the present invention is indicated not by the above meaning but by the claims, and should be understood to include all modifications within the meaning and scope equivalent to the scope of the claims.

For example, while, in the above embodiment, a spring biasing the engagement element toward the unlocked position is mounted in the base holder, since, in a state in which the locking bar is not inserted in the locking bar insertion hole, the engagement element is retained at the unlocked position by its own weight, too, such a spring does not necessarily need to be mounted.

The parting locking device of the present invention can be mounted to not only a horizontal injection molding machine as in the embodiment but also a vertical injection molding machine. If the parting locking device is mounted to a vertical injection molding machine, since the own weight of the engaging element does not act in the direction in which the engaging element is retained at the unlocked position, a spring as used in the embodiment is preferably mounted.

### DESCRIPTION OF REFERENCE NUMERALS

1: Nozzle (of an injection device)
2: Spool bush
3: Spool plate
4: Stripper plate
5: Fixed mold
6: Cavity
7: Movable mold
8: Movable plate
9: Cylinder
10: Parting locking device
11; Base holder
11a: Holder body
12: Releasing bar
12a, 12b: Abutment portion
13: Locking bar
13a: First cam portion
13b: Second cam portion
14: Engagement element
14b, 14f: Stopper portion
14c: First engagement portion
14d: Second engagement portion
15: Spring
16: Releasing bar insertion hole
17: Locking bar insertion hole
18: Guide hole
18a: Communication path
18b: Storage recess
19: Partition wall
P: Product
R: Runner portion

1. A parting locking device comprising:
a base holder having a releasing bar insertion hole and a locking bar insertion hole extending parallel to each other;
a releasing bar insertable into and removable from the releasing bar insertion hole;
a locking bar insertable into and removable from the locking bar insertion hole; and
an engagement element disposed in the base holder,
wherein the base holder has a guide hole for guiding movement of the engagement element in a direction orthogonal to a direction in which the releasing bar insertion hole and the locking bar insertion hole extend,
wherein the guide hole includes:
a communication path extending through a partition wall between the releasing bar insertion hole and the locking bar insertion hole; and
a storage recess formed in an inner surface of a side wall opposed to the partition wall with the locking bar insertion hole located between the side wall and the partition wall,
wherein the engagement element includes:
a stopper portion configured to retractably protrude into the releasing bar insertion hole from the communication path of the guide hole;
a first engagement portion configured to retractably protrude into the locking bar insertion hole from the communication path of the guide hole; and
a second engagement portion configured to retractably protrude into the locking bar insertion hole from the storage recess of the guide hole,
wherein the releasing bar includes an abutment portion disposed at an insertion distal end portion of the releasing bar configured to be inserted into the releasing bar insertion hole, the abutment portion being configured to abut against the stopper portion protruding into the releasing bar insertion hole,
wherein the locking bar includes:
a recessed first cam portion configured to selectively receive the first engagement portion of the engagement element, and push the first engagement portion into the communication path of the guide hole according to directions in which the locking bar moves when the locking bar is inserted and removed; and
a second cam portion configured such that the second engagement portion of the engagement element protruding into the locking bar insertion hole is pushed into the storage recess of the guide hole by the second cam portion,
wherein the parting locking device is configured such that in a state in which the locking bar is not inserted in the locking bar insertion hole, the engagement element is at an unlocked position in which the stopper portion protrudes into the releasing bar insertion hole so as to prevent insertion of the releasing bar, the first engagement portion retracts into the communication path of the guide hole, and the second engagement portion protrudes into the locking bar insertion hole,
wherein the parting locking device is configured such that when the locking bar is inserted into the locking bar insertion hole, the second cam portion pushes the second engagement portion of the engagement element, so that the engagement element moves to a locked position in which the second engagement portion retracts into the storage recess of the guide hole, the first engagement portion protrudes into the locking bar insertion hole and enters the first cam portion of the locking bar, and the stopper portion retracts into the communication path of the guide hole,
wherein the parting locking device is configured such that when the engagement element is at the locked position, the releasing bar inserted in the releasing bar insertion hole restricts movement of the engagement element to the unlocked position, thereby preventing the locking bar from moving out of the locking bar insertion hole, and
wherein the parting locking device is configured such that when the locking bar is pulled out of the locking bar insertion hole in a state in which the engagement element is at the locked position and the releasing bar is not inserted in the releasing bar insertion hole, the first cam portion pushes the first engagement portion of the engagement element, thereby returning the engagement element to the unlocked position.

2. The parting locking device according to claim 1, wherein a spring biasing the engagement element toward the unlocked position is disposed in the base holder.

3. The parting locking device according to claim 1, wherein the stopper portion of the engagement element has a thickness dimension smaller than a thickness dimension of the releasing bar,
wherein the releasing bar has a recess disposed in a portion of the insertion distal end portion in a thickness direction, and including the abutment portion, and
wherein the releasing bar has convex circular arc-shaped surfaces on both sides of a distal end surface of a portion of the insertion distal end portion other than the recess of the releasing bar.

4. The parting locking device according to claim 2, wherein the stopper portion of the engagement element has a thickness dimension smaller than a thickness dimension of the releasing bar,
wherein the releasing bar has a recess disposed in a portion of the insertion distal end portion in a thickness direction, and including the abutment portion, and
wherein the releasing bar has convex circular arc-shaped surfaces on both sides of a distal end surface of a portion of the insertion distal end portion other than the recess of the releasing bar.
